(19) United States
(12) Patent Application Publication
(10) Pub. No.: US 2025/0316277 A1
(43) Pub. Date: Oct. 9, 2025

(54) AUDIO PROCESSING METHOD AND APPARATUS, ELECTRONIC DEVICE AND COMPUTER-READABLE STORAGE MEDIUM

(71) Applicant: Beijing Zitiao Network Technology Co., Ltd., Beijing (CN)

(72) Inventors: He WANG, Beijing (CN); Shenyi SONG, Beijing (CN); Dejun ZHANG, Beijing (CN); Ziqian WU, Beijing (CN); Jiawei JIANG, Beijing (CN); Kunpeng LIN, Beijing (CN); Canrui WU, Beijing (CN); Yijian XIAO, Beijing (CN); Piao DING, Beijing (CN)

(21) Appl. No.: 19/245,081

(22) Filed: Jun. 20, 2025

Related U.S. Application Data
(63) Continuation of application No. PCT/CN2023/140298, filed on Dec. 20, 2023.

(30) Foreign Application Priority Data
Dec. 20, 2022 (CN) 202211644426.1

(51) Int. Cl. G10L 19/005; G10L 19/002; G10L 19/008

(52) U.S. Cl. CPC G10L 19/005; G10L 19/002; G10L 19/008

(57) ABSTRACT

This disclosure provides an audio processing method and apparatus, an electronic device, and a computer-readable storage medium. The audio processing method includes: determining flag bit data based on encoded data information of an audio frame, wherein the encoded data information comprises at least one of configuration information of Multiple Description Coding (MDC), configuration information of in-band Forward Error Correction (FEC) encoding or configuration information of Bandwidth Extension (BWE) data (S201); and writing the flag bit data into a bitstream (S202).

### CROSS REFERENCE TO RELATED APPLICATIONS

The present disclosure is a continuation of International Patent Application No. PCT/CN2023/140298, filed on Dec. 20, 2023, which claims priority to Chinese Patent Application No. 202211644426.1, filed on Dec. 20, 2022, the disclosures of which are hereby incorporated into this disclosure by reference in their entireties.

### TECHNICAL FIELD

Embodiments of the present disclosure relate to the technical field of audio processing, particularly to an audio processing method and apparatus, an electronic device, and a non-transitory computer-readable storage medium.

### BACKGROUND

When the network signal is poor, encoded data from a continuous audio stream is prone to packet loss during transmission, resulting in audio playback stuttering, missing audio frames, and other issues.

At present, electronic devices can use Forward Error Correction (FEC) encoding technology to process encoded audio data, thereby avoiding the impact of packet loss on audio. For example, when a sender encodes audio data of a current frame, encoded audio data of one previous frame can be carried in the encoded data. In this way, if the audio data of the previous frame is lost, the receiver can decode the audio data of the previous frame based on the encoded audio data of the previous frame contained in the encoded data of the current frame. However, if there is continuous packet loss (e.g. if 10 consecutive frames of audio data packets have been lost at the receiver), in-band FEC encoding cannot effectively recover the audio data, resulting in poor audio playback performance.

### SUMMARY

This disclosure provides an audio processing method, apparatus, electronic device, and computer-readable storage medium for solving the technical problem of poor audio playback effect in the prior art.

In the first aspect, the present disclosure provides an audio processing method, comprising:
determining flag bit data based on encoded data information of an audio frame, wherein the encoded data information comprises at least one of configuration information of Multiple Description Coding (MDC), configuration information of in-band Forward Error Correction (FEC) encoding or configuration information of Bandwidth Extension (BWE) data; and
writing the flag bit data into a bitstream.

In a second aspect, the present disclosure provides another audio processing method, comprising:
determining encoded data information based on flag bit data in a bitstream, wherein the encoded data information comprises at least one of configuration information of MDC, configuration information of in-band FEC encoding or configuration information of BWE data;
obtaining target encoded data from the bitstream based on the encoded data information; and
decoding the target encoded data to obtain an audio frame.

In a third aspect, the present disclosure provides an audio processing apparatus, comprising:
a determination module configured for determining flag bit data based on encoded data information of an audio frame, wherein the encoded data information comprises at least one of configuration information of Multiple Description Coding (MDC), configuration information of in-band Forward Error Correction (FEC) encoding or configuration information of Bandwidth Extension (BWE) data; and
a writing module configured for writing the flag bit data into a bitstream.

In a fourth aspect, the present disclosure provides an audio processing apparatus, comprising:
a determination module configured for determining encoded data information based on flag bit data in a bitstream, wherein the encoded data information comprises at least one of configuration information of MDC, configuration information of in-band FEC encoding or configuration information of BWE data;
an obtaining module configured for obtaining target encoded data from the bitstream based on the encoded data information; and
a decoding module configured for decoding the target encoded data to obtain the audio frame.

In a fifth aspect, an embodiment of the present disclosure provides an electronic device, comprising:
a memory;
a processor configured to execute computer execution instructions stored in the memory to cause the processor to preform any of the audio processing methods described above.

In a sixth aspect, an embodiment of the present disclosure provides a non-transitory computer-readable storage medium having stored thereon computer execution instructions that, when executed by a processor, implement any of the audio processing methods described above.

In a seventh aspect, an embodiment of the present disclosure provides a computer program product comprising a computer program that, when executed by a processor, implements any of the audio processing methods described above.

In an eighth aspect, an embodiment of the present disclosure provides a computer program, comprising: instructions that, when executed by a processor, cause the processor to perform any of the audio processing methods described above.

### BRIEF DESCRIPTION OF THE DRAWINGS

In order to more clearly explain the embodiments of the present invention or the technical solutions in the prior art, a brief introduction will be given below for the drawings required to be used in the description of the embodiments or the prior art. It is obvious that the drawings illustrated as follows are merely some embodiments of the present disclosure. For a person skilled in the art, he or she may also acquire other drawings according to such drawings on the premise that no inventive effort is involved.

FIG. 1 is a schematic diagram of an application scenario provided by an embodiment of the present disclosure;

FIG. 2 is a flowchart of an audio processing method provided by an embodiment of the present disclosure;

FIG. 3 is a schematic diagram of flag bit data provided by an embodiment of the present disclosure;

FIG. 4 is a schematic diagram of the audio data of the Nth previous frame provided by an embodiment of the present disclosure;

FIG. 5 is a schematic diagram of another audio processing method provided by an embodiment of the present disclosure;

FIG. 6 is a schematic structure diagram of an audio processing apparatus provided by an embodiment of the present disclosure;

FIG. 7 is a schematic structure diagram of another audio processing apparatus provided by an embodiment of the present disclosure; and

FIG. 8 is a schematic structure diagram of a first device provided by an embodiment of the present disclosure.

### DETAILED DESCRIPTION

Exemplary embodiments will be described in detail herein with examples illustrated in the accompanying drawings. When the following description refers to the accompanying drawings, the same numerals in different drawings represent the same or similar elements unless otherwise indicated. The embodiments described in the following exemplary embodiments do not represent all embodiments consistent with the present disclosure. Instead, they are merely examples of devices and methods consistent with aspects of the present disclosure as detailed in the appended claims.

For ease of understanding, the concepts involved in the embodiments of the present disclosure will be explained below.

First device: The first device is a device with wireless transmission and reception capabilities. The first device can be deployed on land in various ways, including as a handheld or wearable device, or mounted on a vehicle, or can be deployed on water surfaces (e.g., ships, etc.). The first device may be a mobile phone, a Pad, a computer with wireless transmission and reception function, a virtual reality (VR) first device, an augmented reality (AR) first device, a wireless terminal in industrial control, a vehicle mounted first device, a wireless terminal in autonomous (self) driving, a wireless first device in remote medical applications, a wireless first device in smart grids, a wireless first device in transportation safety systems, a wireless first device in smart cities, and a wireless first device in smart homes, a wearable first device, etc. The first device involved in the embodiments of the present disclosure may also be referred to as a terminal, user equipment (UE), a first access device, a vehicle mounted terminal, an industrial control terminal, a UE unit, a UE station, a mobile station, a mobile node, a remote station, a first remote device, a mobile device, an UE electronic device, a wireless communication device, an UE agent or UE device, etc. The electronic device can be either fixed or mobile. Optionally, a second device can be the same as the first device, which is not specifically limited in the embodiments of the present disclosure.

In related technologies, in order to avoid the problem of audio stuttering caused by audio packet loss during audio data transmission, the sender can use in-band FEC to process the audio data. In-band FEC can restore lost audio data packets. For example, when encoding the audio data of a current frame, the sender can add the encoded audio data of a previous frame to the encoded data. In this way, when the audio data packet of the previous frame is lost, the receiver can decode the audio frame of the previous frame based on the encoded audio data of the previous frame contained in the encoded data of the current frame. However, if the receiver experiences continuous packet loss (for example, if it loses 10 consecutive frames of audio data packets), it cannot restore the lost data, which causes lag and interruption to the audio playback, resulting in poor performance.

In order to solve technical problems in related technologies, an embodiment of the present disclosure provides an audio processing method. In order to improve the playback effect of decoded audio, data carried by target encoded data of an audio frame may include at least one of: at least two pieces of first audio encoded data of the audio frame, second audio encoded data of the Nth previous audio frame, and BWE data of the audio frame. In order to accurately identify these data, an encoding device (e.g., a first device) can determine flag bit data associated with the audio frame and obtain a configuration value associated with the flag bit data. Based on the configuration value, data that the target encoded data of the audio frame can carry can be determined. Then, the encoding device can send the target encoded data and the flag bit data to a decoding device (e.g., a second device), and the decoding device decodes the received bitstream based on the flag bit data to obtain the audio frame. In this way, when consecutive packet loss occurs, the decoding device can restore the lost audio data based on the first encoded audio data, the second encoded audio data, and the flag bit data, and improve audio clarity based on the BWE data. Since the flag bit data can assist the second device in decoding the target encoded data, the second device can accurately decode the target encoded data, thereby improving the audio quality and enhancing the audio playback effect.

In some embodiments, the first device may also determine the flag bit data associated with the audio frame and obtain a configuration value associated with the flag bit data. Based on the configuration value, data that can be carried by the target encoded data of the audio frame can be determined. The data carried by the target encoded data may include at least one of: at least two pieces of first encoded audio data of the audio frame, second encoded audio data of the Nth previous audio frame, or BWE data of the audio frame. The first device sends the target encoded data and the flag bit data to a second device, and the second device decodes the target encoded data based on the flag bit data to obtain the audio frame. In this way, when consecutive packet loss occurs, the second device can restore the lost audio data based on the first encoded audio data and the second encoded audio data, and improve audio clarity based on the BWE data. Since the flag bit data can assist the second device in decoding the target encoded data, the second device can accurately decode the target encoded data, thereby improving the audio quality and enhancing the audio playback effect.

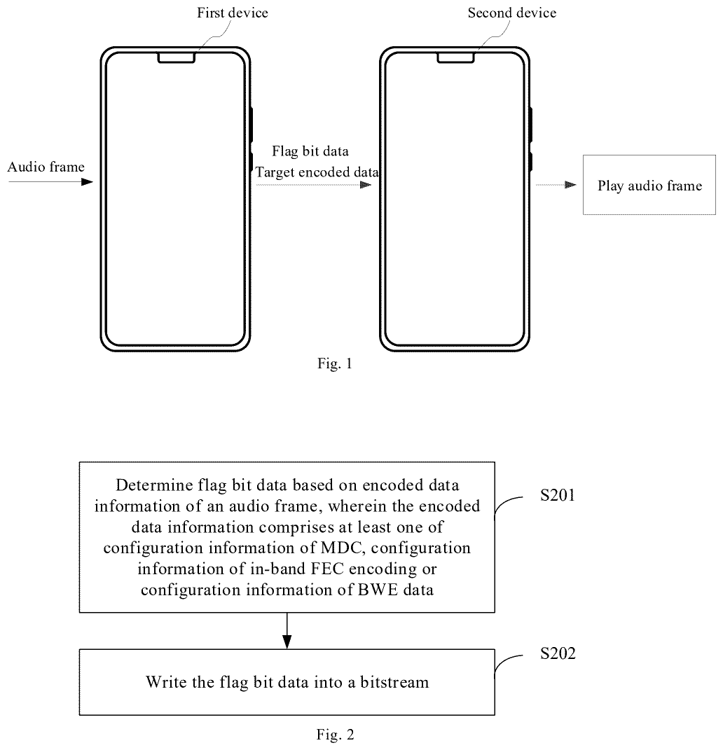

Below an application scenario of the embodiments of the present disclosure will be explained with reference to FIG. 1.

FIG. 1 is a schematic diagram of an application scenario provided by an embodiment of the present disclosure. Referring to FIG. 1, there are a first device and a second device, wherein the first device may be communicatively connected to the second device. When the first device obtains an audio frame, it can obtain flag bit data and target encoded data of the audio frame. The target encoded data of the audio frame can carry two streams (channels) of first encoded audio data of the audio frame, encoded audio data of the Nth previous frame, and BWE data. The first device can write the flag bit data and target encoded data into a bitstream and send the bitstream to the second device.

In some embodiments, when the first device receives an audio frame, the first device may obtain the flag bit data of the audio frame. If the flag bit data indicates the first device to send the audio frame, the target encoded data of the audio frame may carry two streams of first encoded audio data of the audio frame, the encoded audio data of the Nth previous frame, and BWE data. Then, the first device may determine the target encoded data and send the flag bit data and the target encoded data to the second device.

Referring to FIG. 1. when the second device receives the flag bit data and the target encoded data, the second device can determine encoded data carried by the target encoded data based on the flag bit data, and then obtain and play the audio frame by assisting the second device in decoding the target encoded data using the flag bit data. In this way, the second device can restore a lost audio frame based on the first encoded audio data and the second encoded audio data, improve the clarity of the audio frame based on the BWE data, and assist in decoding the target encoded data based on the flag bit data, thereby improving the audio quality and enhancing the audio playback effect.

It should be noted that FIG. 1 is merely an exemplary illustration of an application scenario for the present disclosure and does not limit the application scenarios for the embodiments of the present disclosure.

The following provides a detailed explanation of the technical solution of the present disclosure and how it solves the aforementioned technical problems in conjunction with specific embodiments. The following specific embodiments can be combined with each other, and the same or similar concepts or processes may not be repeated in some embodiments. Below, embodiments of the present disclosure will be described with reference to the accompanying drawings.

FIG. 2 is a flowchart of an audio processing method provided by an embodiment of the present disclosure. Referring to FIG. 2, the method may include steps S201 and S202.

In S201, flag bit data is determined based on encoded data information of an audio frame, wherein the encoded data information includes at least one of configuration information of MDC encoding, configuration information of in-band FEC encoding, or configuration information of BWE data. That is, flag bit data associated with the audio frame is determined.

The subject of execution of this embodiment may be the first device or an audio processing apparatus provided in the first device. Optionally, the audio processing apparatus can be implemented based on software or a combination of software and hardware, which is not specifically limited herein.

Optionally, the audio frame may be an audio frame to be sent in an audio. For example, an audio segment consists of 10 audio frames. In the case of sending the audio segment by the first device, the first device can determine any audio frame in the segment as the audio frame to be sent. For example, in the process of audio transmission, multiple audio frames can be cached in a buffer pool for transmission. The first device can retrieve audio frames in their playback order and encode them separately, and then send the encoded data of the audio frames based on the playback order.

Optionally, the audio frame can be an audio frame obtained in real time by the first device. For example, in a real-time voice transmission scenario, when a user outputs a real-time speech, the first device can collect it and obtain audio frames of the real-time speech.

Optionally, the first device can retrieve an audio from a memory and obtain audio frames of the audio. For example, the first device can store multiple audios in advance. In practical applications, the first device can obtain audio frames from any one of the multiple audios. It should be noted that the first device can also obtain audio frames in other ways (e.g., obtaining audio frames of a real-time speech), which are not specifically limited herein.

The flag bit data can indicate the types of encoded data included in the target encoded data of the audio frame, i.e., different parts included in the target encoded data. For example, the flag bit data can indicate flag bits of a plurality of types of encoded data. Based on the value corresponding to the flag bit data, the types of encoded data carried in the target encoded data of the audio frame when encoding the audio frame by the first device can be determined, and corresponding encoded data can be generated according to the types.

Optionally, the types of encoded data include a MDC encoding type, an in-band encoding type, and an extension encoding type. For example, encoded data obtained by encoding an audio frame based on a multiple description encoder (MDC encoding method) is of a MDC type, encoded data obtained by encoding the audio frame based on an in-band encoder (in-band encoding method) is of an in-band coding type, and encoded data obtained by encoding the audio frame based on an extension encoder (extension encoding method) is of an extension coding type.

In some embodiments, the configuration information of MDC includes information on whether to carry MDC-encoded data, or includes information on whether to carry the MDC-encoded data and index information of the MDC-encoded data; the configuration information of in-band FEC encoding comprises information on whether to carry in-band FEC-encoded data, or comprises information on whether to carry the in-band FEC-encoded data and offset index information of the in-band FEC-encoded data; and the configuration information of BWE data comprises information on whether to carry the BWE data, or comprises information on whether to carry the BWE data and extension mode information of the BWE data.

Optionally, the flag bit data can be the data in a control byte. When decoding on the second device, the control byte can describe the content of the encoded data, and the flag bit data carried by the control byte can indicate that encoded data is included in the code of the audio frame. For example, the control byte associated with encoded data may include 8 bits, with the first 6 bits storing flag bit data and the last 2 bits being reserved bits. If the flag bit data in the first 6 bits indicates that the code of the audio frame includes in-band FEC code, the first device can also send in-band FEC code when sending the code of the audio frame.

Optionally, the first device can encode the audio frame based on network status. For example, if the network status of the first device is good, the target encoded data can carry multiple types of encoding information. If the network status of the first device is poor, the target encoded data can carry encoded data that is necessary for decoding the current audio frame without carrying other encoded data (e.g., in-band FEC code) to assist with decoding. Then, the first device can obtain the flag bit data of the audio frame based on the encoding result.

Optionally, the first device can obtain the flag bit data of the audio frame based on the network status. For example, if the network status of the first device is good, the flag bit data can indicate that the encoded data of the audio frame can carry multiple types of encoding information. If the network status of the first device is poor, the flag bit data can indicate that the encoded data of the audio frame carries encoded data that is necessary for decoding the current audio frame without carrying other encoded data (such as in-band FEC code) to assist with decoding.

Optionally, the flag bit data can be preset data on the first device. For example, the first device can store flag bit data in advance, and when the first device sends the encoded data of any audio frame to the second device, the first device can determine the encoded data that can be carried in the code of the audio frame based on the pre-stored flag bit data. It should be noted that the first device can also determine the flag bit data based in other manners, which are not specifically limited herein.

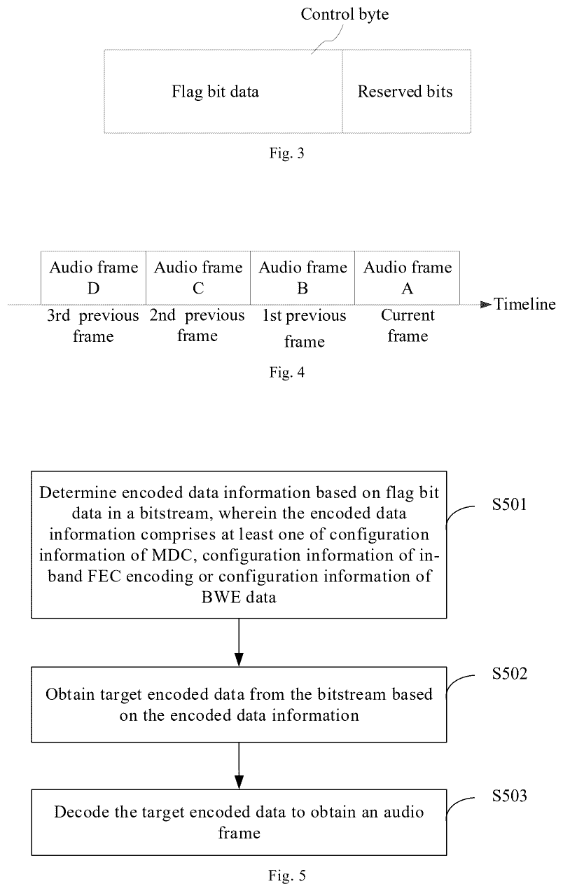

Next, the flag bit data will be explained with reference to FIG. 3.

FIG. 3 is a schematic diagram of flag bit data provided by an embodiment of the present disclosure. Referring to the control byte in FIG. 3, the control byte may be a frame header of the encoded data of an audio frame sent from the first device. The first device can also send the control byte and the encoded data of the audio frame separately, which is not specifically limited in this embodiment.

Referring to FIG. 3, the control byte includes flag bit data and reserved bits. The flag bit data is used to indicate the encoded data included in the code of the audio frame. The reserved bits can be used for new encoding definitions and then for transmitting extended information. The control byte may include 8 bits. The first 6 bits of the control byte can be used to store flag bit data, while the last 2 bits of the control byte can be reserved bits. If the first 6 bits are not sufficient to store the flag bit, both the first 6 bits and the last 2 bits can be used to store the flag bit data.

The target encoded data includes at least one of: first encoded audio data of the audio frame, second encoded audio data of the Nth previous audio frame of the audio frame, and BWE data of the audio frame, the BWE data being associated with the decoding bandwidth of the audio frame, where N is an integer greater than 0.

The first encoded audio data may be an encoded bitstream associated with the audio frame. For example, the first encoded audio data may be a MDC bitstream. By processing the audio frame using a multiple description encoder, a plurality of MDC bitstreams can be obtained. The first device can determine each of the MDC bitstreams as the first encoded audio data of the audio frame. Optionally, after the multiple description encoder processes the audio frame, a plurality of encoded audio bitstreams that are associated with the audio frame can be obtained. Each encoded audio bitstream has the same encoded data. In this way, when sending the encoded data of the audio frame to the receiver, the sender can simultaneously send the plurality of encoded audio bitstreams. Even if packet loss occurs, the audio frame can be restored by means of the plurality of complementary encoded audio bitstreams. Each encoded audio bitstream received by the receiver can improve the quality of the decoded audio frame. For example, the audio frame is processed based on a MDC method (multiple description coding) to obtain first encoded audio data.

Optionally, for any first encoded audio data of the audio frame, it can be determined by the first device through: obtaining frame header information of the audio frame. For example, the frame header information may include information such as the length, encoding bandwidth, and the number of streams of the audio frame, which is not limited in this embodiment. The audio frame is processed based on the MDC method to obtain a plurality of encoded audio bitstreams, wherein the plurality of encoded audio bitstreams carry the same encoded data. The frame header information is combined with any one of the audio encoding bitstreams to obtain the first encoded audio data of the audio frame.

The second encoded audio data may be the encoded data of several audio frames starting from the Nth frame preceding the audio frame, where N is an integer greater than 0. For example, the several audio frames starting from the Nth frame may be the 1st, 2nd, or 3rd frame preceding the current audio frame, or two frames starting from the 5th previous frame. For example, the above audio frame is processed based on an method of in-band FEC coding type (in-band FEC coding) to obtain the second encoded audio data.

Next, the audio data of the Nth previous frame will be explained with reference to FIG. 4.

FIG. 4 is a schematic diagram of audio data of the Nth previous frame provided by an embodiment of the present disclosure. Referring to FIG. 4, it includes a timeline, audio frame A, audio frame B, audio frame C, and audio frame D, wherein audio frame A is the current frame, audio frame B is the first previous frame of the current frame, audio frame C is the second previous frame of the current frame, and audio frame D is the third previous frame of the current frame.

Referring to FIG. 4. If N is 1, the first device determines audio frame B as the audio frame of the Nth previous frame. If N is 2, the first device determines audio frame C as the audio frame of the Nth previous frame. If N is 3, the first device determines audio frame D as the audio frame of the Nth previous frame.

Optionally, the BWE data is associated with the decoding bandwidth of the audio frame, wherein the decoding bandwidth may be the bandwidth of the audio frame obtained after decoding. For example, the first device can determine BWE data based on BWE technology, which can be used to improve the playback quality of the audio frame. For example, BWE data of the audio frame can be determined by processing the audio frame using BWE technology. The receiver decodes the audio frame based on the BWE data, which can increase the bandwidth of the audio frame and thus improve its clarity.

Target encoded data of the audio frame can be determined through obtaining a configuration value associated with the flag bit data, and determining the target encoded data of the audio frame based on the configuration value. In practical applications, for example, the flag bit data in the control byte is binary data, and the configuration value may be the result of converting this data to decimal. For example, if the flag bit data is 11111, the configuration value associated with the flag bit data is 31, and if the flag bit data is 111111, the configuration value associated with the flag bit data is 63.

Optionally, determining target encoded data for the audio frame based on the configuration value particularly includes: determining, based on the configuration value, target parameters corresponding to at least one information (also known as target information) associated with the configuration value, and determining the target encoded data for the audio frame based on the target parameters.

Optionally, the target information includes at least one of: whether the target encoded data can carry multiple first encoded audio data, an index of the first encoded audio data, whether the target encoded data can carry second encoded audio data, an offset index of the second encoded audio data, whether the target encoded data can carry BWE data, and the extension mode of the BWE data.

The index of the first encoded audio data is used to indicate the first encoded audio data. For example, if the target encoded data carries multiple first encoded audio data, the second device at the receiver can extract the first encoded audio data from the target encoded data based on the index of the first encoded audio data.

The offset index of the second encoded audio data is used to indicate the offset of the second encoded audio data. For example, the second encoded audio data is the audio code of the Nth previous audio frame, and the offset may be N. The offset is 1 if N is 1, and the offset is 2 if N is 2.

The extension mode of the BWE data is used to indicate the mode of the BWE data that the second device can use during decoding. For example, in practical applications, there may be multiple preset BWE data extension modes, and the second device can determine an extension mode used for decoding the target encoded data based on the target information.

Optionally, the target parameters are the parameters associated with the target information. Below, the correspondence between target information and target parameters will be explained based on Table 1.

TABLE 1

| Whether to carry multiple | | Whether to carry |
|---|---|---|
| piece of first encoded audio | Index of the first | second encoded |
| data | encoded audio data | audio data |
| 0/1 | 0/1 | 0/1 |

| Offset index of the second | Whether to carry | Extension mode of |
|---|---|---|
| encoded audio data | BWE data | the BWE data |
| 0/1/2/3 | 0/1 | 0/1 |

For example, the target parameter for whether the target encoded data can carry multiple first encoded audio data may be 0 or 1. If the target parameter is 0, the target encoded data cannot carry multiple first encoded audio data. If the target parameter is 1, the target encoded data can carry multiple first encoded audio data.

For example, the target parameter associated with the index of the first encoded audio data may be 0 or 1. If the target parameter is 0, the first encoded audio data is first encoded audio data of first stream obtained by the first device. If the target parameter is 1, the first encoded audio data is first encoded audio data of second stream obtained by the first device.

For example, the target parameter associated with whether the target encoded data can carry second encoded audio data may be 0 or 1. If the target parameter is 0, the target encoded data cannot carry the second encoded audio data. If the target parameter is 1, the target encoded data can carry the second encoded audio data.

For example, the target parameter associated with the offset index of second encoded audio data may be 0, 1, 2, or 3. If the target parameter is 0, the second encoded audio data is the encoded data of the 1st previous audio frame. If the target parameter is 1, the second encoded audio data is the encoded data of the 2nd previous audio frame. If the target parameter is 2, the second encoded audio data is the encoded data of the 3rd previous audio frame. If the target parameter is 3, the second encoded audio data is the encoded data of the 4th previous audio frame.

For example, the target parameter associated with whether the target encoded data can carry BWE data may be 0 or 1. If the target parameter is 0, the target encoded data cannot carry the BWE data. If the target parameter is 1, the target encoded data can carry the BWE data.

For example, the target parameter associated with the extension mode of BWE data can be 0 or 1. If the target parameter is 0, the extension mode of BWE data is the 1st extension mode. If the target parameter is 1, the extension mode of BWE data is the 2nd extension mode.

Note that the values illustrated in Table 1 are merely examples of the target parameters and do not constitute limitations. For example, the target parameters in Table 1 include a total of 128 combinations. Therefore, the flag bit data can be represented by up to 7 bits. For example, if the flag bit data is 1111111, a configuration value associated with the flag bit data is 127. Therefore, the second device can determine the target information based on the 127th combination (each combination is associated with a configuration value).

Optionally, determining, based on the configuration value, target parameters corresponding to at least one target information associated with the configuration value particularly comprises: obtaining a first relationship, which includes at least one configuration value (used for the flag bit data) and target parameters (which can be considered as the Value of the configuration information) corresponding to at least one type of target information (which can be considered as the Key of the configuration information in the target encoded data) associated with the configuration value. For example, based on the encoded data information of the audio frame, a parameter value can be determined for each piece of configuration information in the encoded data information of the audio frame based on the encoded data information of the audio frame; and the flag bit data is determined based on a first relationship and the parameter value for the each piece of configuration information, wherein the first relationship comprises a correspondence among target parameter values of the configuration information of MDC, the configuration information of in-band FEC encoding and the configuration information of BWE data, and configuration value(s) of one or more flag bit data. Below, the first preset relationship will be explained in conjunction with Tables 2 and 3. For ease of explanation, the configuration information of MDC, the configuration information of in-band FEC encoding, and the configuration information of BWE data can be collectively referred to as “target information”.

It should be noted that due to the limited bit width in the control byte, only a limited number of target parameter combinations can be represented by the flag bit data. In order to save bit width resources in the control byte, the combination of target parameters must satisfy at least one of condition 1 and condition 2.

Condition 1: In the case where the bitstream does not carry MDC-encoded data, the bitstream does not carry in-band FEC-encoded data and BWE data, and all of the target parameter values corresponding to the index information of the MDC-encoded data, the offset index information of the in-band FEC-encoded data, and the extension mode information of the BWE data are Null. If the target encoded data cannot carry multiple first encoded audio data, the remaining target parameters can be 0 or Null.

In this case, in the first relationship, in response to the target parameter value of whether to carry the MDC-encoded data indicating not carrying the MDC-encoded data, the target parameter value of whether to carry the in-band FEC-encoded data indicates not carrying the in-band FEC-encoded data, the target parameter value of whether to carry the BWE data indicates not carrying the BWE data, and all of target parameter values of index information of the MDC-encoded data, offset index information of the in-band FEC-encoded data, and extension mode information of the BWE data are Null.

Specifically, if the target encoded data cannot carry multiple first encoded audio data, it means that the target parameter associated with this target information is 0. Therefore, the target encoded data does not include the first encoded audio data, and the target parameter of the index of the first encoded audio data is Null. The encoder will not obtain second encoded audio data and BWE data (their target parameters are Null). Therefore, the target parameter associated with whether the target encoded data can carry second encoded audio data is 0, and the target parameter associated with whether the target encoded data can carry BWE data is 0.

When condition 1 is met, there may be 31 combinations of the target parameters, and 31 situations of the encoded data that can be carried in the target encoded data. Therefore, the flag bit data only needs 5 bits to describe these 31 situations. The relationship between the configuration values and the 31 combinations of target parameters is explained below, with reference to Table 2.

TABLE 2

| | | MDC | In-band | In-band | | |
|---|---|---|---|---|---|---|
| Config- | MDC | bit- | FEC | FEC | BWE | |
| uration | indi- | stream | indi- | offest | indi- | BWE |
| values | cator | index | cator | index | cator | index |
| 0 | 0 | Null | 0 | Null | 0 | Null |
| 1 | 1 | 0 | 0 | Null | 0 | Null |
| 2 | 1 | 0 | 0 | Null | 1 | 0 |
| 3 | 1 | 0 | 0 | Null | 1 | 1 |
| 4 | 1 | 0 | 1 | 0 | 0 | Null |
| 5 | 1 | 0 | 1 | 0 | 1 | 0 |
| 6 | 1 | 0 | 1 | 0 | 1 | 1 |
| 7 | 1 | 0 | 1 | 1 | 0 | Null |
| 8 | 1 | 0 | 1 | 1 | 1 | 0 |
| 9 | 1 | 0 | 1 | 1 | 1 | 1 |
| 10 | 1 | 0 | 1 | 2 | 0 | Null |
| 11 | 1 | 0 | 1 | 2 | 1 | 0 |
| 12 | 1 | 0 | 1 | 2 | 1 | 1 |
| 13 | 1 | 0 | 1 | 3 | 0 | Null |
| 14 | 1 | 0 | 1 | 3 | 1 | 0 |
| 15 | 1 | 0 | 1 | 3 | 1 | 1 |
| 16 | 1 | 1 | 0 | Null | 0 | Null |
| 17 | 1 | 1 | 0 | Null | 1 | 0 |
| 18 | 1 | 1 | 0 | Null | 1 | 1 |
| 19 | 1 | 1 | 1 | 0 | 0 | Null |
| 20 | 1 | 1 | 1 | 0 | 1 | 0 |
| 21 | 1 | 1 | 1 | 0 | 1 | 1 |
| 22 | 1 | 1 | 1 | 1 | 0 | Null |
| 23 | 1 | 1 | 1 | 1 | 1 | 0 |
| 24 | 1 | 1 | 1 | 1 | 1 | 1 |
| 25 | 1 | 1 | 1 | 2 | 0 | Null |
| 26 | 1 | 1 | 1 | 2 | 1 | 0 |
| 27 | 1 | 1 | 1 | 2 | 1 | 1 |
| 28 | 1 | 1 | 1 | 3 | 0 | Null |
| 29 | 1 | 1 | 1 | 3 | 1 | 0 |
| 30 | 1 | 1 | 1 | 3 | 1 | 1 |

It should be noted that in Table 2, the MDC identifier represents whether the target encoded data of this disclosure can carry multiple first encoded audio data, the MDC bitstream index is the index of the first encoded audio data of this disclosure, the in-band FEC identifier represents whether the target encoded data of this disclosure can carry the second encoded audio data, the in-band FEC offset index is the index of the offset of the second encoded audio data of this disclosure, the BWE identifier is whether the target encoded data of this disclosure can carry BWE data, and the BWE index is the extension mode of the BWE data of this disclosure.

Optionally, when a first preset relationship shown in Table 2 is provided on the first device, the first device can generate flag bit data by: initializing a configuration value to 0; if the target parameter of the MDC indicator is 0, directly outputting the configuration value; if the target parameter of the MDC indicator is 1: if the target parameter of the MDC bitstream index is 0, determining that the configuration value is 1; if the target parameter of the MDC bitstream index is 1, determining that the configuration value is 16. If both the in-band FEC indicator and BWE indicator have a target parameter of 0, outputting a configuration value of 16; if the target parameter of the in-band FEC indicator is 1, determining an increment of the configuration value based on the in-band FEC offset index value and adding the increment to 16; if the target parameter of the BWE indicator is 1, determining an increment of the configuration value based on the BWE mode and adding it to the previous configuration value to obtain a new configuration value; and determining the flag bit data based on the configuration value.

It should be noted that in Table 2, the first device can obtain two descriptions (streams) of first encoded audio data, and the maximum offset of the second encoded audio data is 4 frames (e.g., it can carry the one preceding frame, two preceding frames, three preceding frames, or four preceding frames). There are two extension modes for BWE data. Table 2 is only an example of 31 combinations of the target parameters. Other target parameter combinations are also possible (e.g., four descriptions of first encoded audio data, and the target parameter associated with the index of the first encoded audio data may be 0, 1, 2, and 3), which is not specifically limited in this disclosure.

Condition 2: In the case where the bitstream carries the MDC-encoded data and the index information of the MDC-encoded data is used to indicate that the MDC-encoded data is encoded data of a first stream, the bitstream does not carry in-band FEC-encoded data and BWE data, and both of the target parameter values corresponding to the offset index information of the in-band FEC-encoded data and the extension mode information of the BWE data are Null. That is, if the target encoded data can carry multiple first encoded audio data, and the target parameter associated with the index of first encoded audio data is 0, the remaining target parameters may be 0 and Null.

In this case, in the first relationship, in response to the target parameter value of whether to carry the MDC-encoded data indicating carrying the MDC-encoded data, and index information of the MDC-encoded data indicating that the carried MDC-encoded data is encoded data of a first stream, the target parameter value of whether to carry the in-band FEC-encoded data indicates not carrying the in-band FEC-encoded data, the target parameter value of whether to carry the BWE data indicates not carrying the BWE data, and all of target parameter values of index information of the MDC-encoded data, offset index information of the in-band FEC-encoded data, and extension mode information of the BWE data are Null; and in the first relationship, in response to the target parameter value of whether to carry the MDC-encoded data indicating carrying the MDC-encoded data, and the index information of the MDC-encoded data indicating that the carried MDC-encoded data is not encoded data of the first stream, the target parameter value of whether to carry the in-band FEC-encoded data indicates carrying or not carrying the in-band FEC-encoded data, and the target parameter value of whether to carry the BWE data indicates carrying or not carrying the BWE data.

Specifically, if the target encoded data can carry multiple first encoded audio data, it indicates that the target parameter associated with the target information is 1; if the target parameter associated with the index of the first encoded audio data is 0, it indicates that the first device retrieves encoded data of the first stream. In the scenario of the encoded data of the first stream, the target encoded data does not need to carry second encoded audio data and BWE data. Therefore, the target parameters associated with whether the target encoded data can carry the second encoded audio data and whether the target encoded data can carry BWE data are 0, and the target parameters associated with the offset index of second encoded audio data and the extension mode of BWE data are Null.

When condition 2 is met, there are 17 target parameter combinations, and 17 situations of the encoded data that can be carried in the target encoded data. Therefore, the flag bit data only needs 5 bits to describe these 17 situations. Below, the relationship between the configuration values and the 17 target parameter combinations will be explained with reference to Table 3.

TABLE 3

| | | | In- | In- | | |
|---|---|---|---|---|---|---|
| | | MDC | band | band | | |
| Config- | MDC | bit- | FEC | FEC | BWE | |
| uration | indi- | stream | indi- | offest | indi- | BWE |
| value | cator | index | cator | index | cator | index |
| 0 | 0 | Null | 0 | Null | 0 | Null |
| 1 | 1 | 0 | 0 | Null | 0 | Null |
| 2 | 1 | 1 | 0 | Null | 0 | Null |
| 3 | 1 | 1 | 0 | Null | 1 | 0 |
| 4 | 1 | 1 | 0 | Null | 1 | 1 |
| 5 | 1 | 1 | 1 | 0 | 0 | Null |
| 6 | 1 | 1 | 1 | 0 | 1 | 0 |
| 7 | 1 | 1 | 1 | 0 | 1 | 1 |
| 8 | 1 | 1 | 1 | 1 | 0 | Null |
| 9 | 1 | 1 | 1 | 1 | 1 | 0 |
| 10 | 1 | 1 | 1 | 1 | 1 | 1 |
| 11 | 1 | 1 | 1 | 2 | 0 | Null |
| 12 | 1 | 1 | 1 | 2 | 1 | 0 |
| 13 | 1 | 1 | 1 | 2 | 1 | 1 |
| 14 | 1 | 1 | 1 | 3 | 0 | Null |
| 15 | 1 | 1 | 1 | 3 | 1 | 0 |
| 16 | 1 | 1 | 1 | 3 | 1 | 1 |

It should be noted that the concepts of the parameters in Table 3 are the same as those in Table 2 and will not be repeated herein.

The target parameters are determined based on the configuration value and the first relationship. For example, in Table 2, if the configuration value is 30, the target parameter for MDC indicator is 1, the target parameter for MDC bitstream index is 1, the target parameter for in-band FEC identifier is 1, the target parameter for in-band FEC offset index is 3, the target parameter for BWE identifier is 1, and the target parameter for BWE index is 1.

Optionally, the first device determines the target encoded data of the audio data based on the target parameters as follows. If the target parameters indicate that the target encoded data can carry multiple first encoded audio data, it is determined that the target encoded data includes first encoded audio data; if the target parameters indicate that the target encoded data can carry second encoded audio data, it is determined that the target encoded data includes the second encoded audio data; if the target parameters indicate that the target encoded data can carry BWE data, it is determined that the target encoded data includes the BWE data.

For example, taking the first relationship shown in Table 2 as an example, if the flag bit data obtained by the first device is 11110, the configuration value associated with the flag bit data is 30, i.e., a target parameter combination is the 31st combination in Table 2. The information indicated by the flag bit data includes that: the target encoded data can carry multiple first encoded audio data; the first encoded audio data carried is the second description, the target encoded data can carry second encoded audio data; the second encoded audio data is the encoded data of the 4th previous audio frame; the target encoded data can carry BWE data; and the extension mode of the BWE data is the second mode. Therefore, the target encoded data includes the first encoded audio data of the second description, the second encoded audio data of the 4th previous audio frame, and the BWE data of the second mode.

For example, taking the first relationship shown in Table 3 as an example, if the flag bit data obtained by the first device is 111, the configuration value associated with this flag bit data is 7, i.e., the target parameter combination is the 8th combination in Table 3. The information indicated by the flag bit data includes that: the target encoded data can carry multiple first encoded audio data; the first encoded audio data carried is the second description; the target encoded data can carry second encoded audio data; the second encoded audio data is the encoded data of the 1st previous audio frame; the target encoded data can carry BWE data, and the extension mode of the BWE data is the second mode. Therefore, the target encoded data includes first encoded audio data of the second description 2, the second encoded audio data of the 1st previous audio frame and the BWE data of the second mode.

Regarding the reserved bits in this embodiment shown in FIG. 3, with reference to Table 4, the encoded data associated with two reserved bits will be explained below as an example.

TABLE 4

| Reserved | Extension type | Extension type | |
|---|---|---|---|
| parameter | indicator 1 | indicator 2 | Notes |
| 0 | 0 | 0 | Data is not carried for both |
| | | | two extension types. |
| 1 | 0 | 1 | Data of extension type 2 is |
| | | | carried, and data of |
| | | | extension type 1 is not |
| | | | carried. |
| 2 | 1 | 0 | Data of extension type 1 is |
| | | | carried, and data of |
| | | | extension type 2 is not |
| | | | carried. |
| 3 | 1 | 1 | Data is carried for both two |
| | | | extension types. |

For example, if the reserved parameter obtained by the first device is 0, it indicates that the target encoded data does not carry data of extension type 1 and extension type 2. If the reserved parameter obtained by the first device is 1, it indicates that the target encoded data does not carry data of extension type 1 and can carry data of extension type 2. If the reserved parameter obtained by the first device is 2, it indicates that the target encoded data can carry data of extension type 1, but not type 2. If the reserved parameter obtained by the first device is 3, it indicates that the target encoded data can carry data of extension type 1 and extension type 2. It should be noted that Table 4 is merely an example of the encoded data that can be indicated by the reserved bits, and the embodiments of the present disclosure are not limited to this example. For example, when the first device generates the reserved bits, it initializes the reserved parameter to 0. An OR operation is performed on the reserved parameter and the parameter of extension type identifier 2. The reserved bit is shifted to the left by 1 bit, and an OR operation is performed on the reserved parameter and the parameter of extension type identifier 1 to obtain the reserved parameter. Then, the reserved parameter is converted into binary code and stored in the reserved bits.

In S202, the flag bit data is written into the bitstream.

Then, the bitstream, i.e., the target encoded data and the flag bit data can be sent to the second device.

Optionally, the first device can send the target encoded data and the flag bit data separately to the second device, or it can concatenate the target encoded data and flag bit data and send the concatenated data to the second device, which is not specifically limited in this embodiment.

In some embodiments, based on encoded data information of an audio frame, flag bit data corresponding to each MDC description is determined.

In some embodiments, the each of the streams of the MDC data is concatenated with the flag bit data corresponding to the each of the streams of the MDC data; and concatenated data is written into the bitstream. It should be noted that when the target encoded data can carry multiple streams of first encoded audio data, each stream can be concatenated with the flag bit data, so that all the different streams include the flag bit data indicating what encoded data can be carried, thereby improving the efficiency of the second device when decoding the target encoded data. In practical applications, each stream can be concatenated with a flag bit data, the second encoded audio data of the Nth previous audio frame, and the BWE data, which is not specifically limited herein.

An embodiment of this disclosure provides an audio processing method, wherein a first device can determine flag bit data of an audio frame based on target encoded data, and write the flag bit data into a bitstream. In this way, the flag bit data can assist in decoding. Therefore, the decoder can decode more accurately, thereby improving the audio quality and enhancing the audio playback effect.

Based on the embodiment shown in FIG. 2, another audio processing method will be explained below with reference to FIG. 5.

FIG. 5 is a schematic diagram of another audio processing method provided by an embodiment of the present disclosure. Referring to FIG. 5, this method includes steps S501 to S503.

In step S501, encoded data information is determined based on flag bit data in a bitstream, wherein the encoded data information includes at least one of configuration information of MDC encoding, configuration information of in-band FEC encoding, or configuration information of BWE data.

For example, the bitstream sent from the first device is received, which includes the target encoded data of the audio frame and the flag bit data.

The subject of execution of this embodiment may be a second device or an audio processing apparatus provided in the second device. Optionally, the audio processing apparatus can be implemented based on software or a combination of software and hardware, which is not specifically limited herein.

Optionally, the flag bit data can indicate data carried in the target encoded data, the target encoded data including at least one of: the first encoded audio data of the audio frame, second encoded audio data of the Nth previous audio frame of the audio frame, or BWE data of the audio frame. It should be noted that the relevant content of the target encoded data has been explained in the above embodiments, and will not be repeated herein.

Then, the target encoded data can be decoded based on the flag bit data to obtain the audio frame.

In step S502, the target encoded data is extracted from the bitstream based on the encoded data information.

In some embodiments, based on the encoded data information, the target encoded data including a plurality of parts is extracted from the bitstream, each part corresponding to an encoding method or encoding type.

In step S503, the target encoded data is decoded to obtain the audio frame.

Optionally, the second device can obtain the audio frame in the following manner: obtaining a configuration value associated with the flag bit data; determining, based on the configuration value, target parameters corresponding to at least one target information associated with the configuration value; extracting data to be decoded from the target encoded data based on the target parameters; and processing the data to be decoded to obtain the audio data. It should be noted that the relevant content of the target information and target parameters has already been explained in the embodiment shown in FIG. 2 and will not be repeated herein.

Optionally, determining, based on the configuration value, target parameters corresponding to at least one target information associated with the configuration value particularly includes: obtaining a first preset relationship, and determining the target parameters based on the configuration value and the first preset relationship. In some embodiments, a parameter value is determined for each configuration information in the encoded data information of the audio frame based on the flag bit data. Based on the first relationship and the parameter value of each piece of configuration information, the encoded data information is determined, wherein the first relationship includes a correspondence among the target parameter values of the configuration information of MDC, the configuration information of in-band FEC encoding and the configuration information of BWE data, and configuration value(s) of one or more flag bit data. For example, during the decoding process of the second device, after obtaining the configuration value, the second device can reverse-parse a combination of target parameters associated with the configuration value, and then determine the encoded data that the second device can extract from the target encoded data.

For example, taking Table 2 as an example, to obtain the target parameter of the MDC indicator, the target parameter is initialized to 0. If the configuration value is greater than 0 and less than or equal to 30, the target parameter is determined to be 1. To obtain a target parameter of the MDC bitstream index, the target parameter is initialized to −1 (error code, indicating that the current bitstream does not carry a MDC bitstream). If the configuration value is greater than or equal to 1 and less than or equal to 15, the target parameter is determined to be 0; if the configuration value is greater than or equal to 16 and less than or equal to 30, the target parameter is determined to be 1. To obtain a target parameter of the in-band FEC identifier, the target parameter is initialized to 0. If the configuration value is greater than or equal to 4 and less than or equal to 15, the target parameter is determined to be 1; if the configuration value is greater than or equal to 19 and less than or equal to 30, the target parameter is determined to be 1; if the configuration value is other values, the target parameter is determined to be 0. To obtain a target parameter of the in-band FEC offset index, the target parameter is initialized to −1. If the configuration value is greater than or equal to 4 and less than or equal to 15, subtract 1 from the configuration value and assign the result to configuration variable A; subtract the remainder of configuration value A divided by 3 from configuration value A, then assign the result to configuration variable B; divide configuration value B by 3 and assign the result to configuration variable C; subtract 1 from configuration value C to obtain the target parameter. If the configuration value is greater than or equal to 19 and less than or equal to 30, subtract 16 from the configuration value and assign the result to configuration value A; subtract the remainder of configuration value A divided by 3 from configuration value A and then assign the result to configuration variable B; divide configuration value B by 3 and assign the result to configuration variable C; subtract 1 from configuration value C to obtain the target parameter. To obtain a target parameter of the BWE indicator, the target parameter is initialized to 0. If the configuration value is greater than 0 and less than or equal to 30, subtract 1 from the configuration value and assign it to configuration value A; assign the remainder of configuration value A divided by 3 to configuration variable B. If configuration value B is greater than 0, the target parameter is determined to be 1. To obtain a target parameter of the BWE index, the target parameter is initialized to −1. If the configuration value is greater than 0 and less than or equal to 30, subtract 1 from the configuration value and assign the result to configuration value A; assign the remainder of configuration value A divided by 3 to configuration variable B. If configuration value B is 1, the target parameter is 0. If configuration value B is 2, the target parameter is 1.

For example, taking Table 3 as an example, when obtaining a target parameter of the MDC indicator, the target parameter is initialized to 0. If the configuration value is greater than 0 and less than or equal to 16, the target parameter is determined to be 1. When obtaining a target parameter of the MDC bitstream index, the target parameter is initialized to −1. If the configuration value is equal to 1, the target parameter is determined to be 0. If the configuration value is greater than or equal to 2 and less than or equal to 16, the target parameter is determined to be 1. When obtaining a target parameter of the in-band FEC identifier, the target parameter is initialized to 0. If the configuration value is greater than or equal to 5 and less than or equal to 16, the target parameter is determined to be 1. When obtaining a target parameter of the in-band FEC offset index, the target parameter is initialized to −1. If the configuration value is greater than or equal to 5 and less than or equal to 16, subtract 2 from the configuration value and assign the result to configuration value A; assign the result of configuration value A minus the remainder of configuration value A divided by 3 to configuration variable B; assign the result of configuration value B divided by 3 to configuration variable C; subtract 1 from configuration value C to obtain the target parameter. When obtaining a target parameter of the BWE indicator, the target parameter is initialized to 0. If the configuration value is greater than 1 and less than or equal to 16, subtract 2 from the configuration value and assign the result to configuration value A; assign the remainder of configuration value A divided by 3 to configuration variable B. If configuration value B is greater than 0, the target parameter is determined to be 1. When obtaining a target parameter of the BWE index, the target parameter is initialized to −1. If the configuration value is greater than 1 and less than or equal to 16, subtract 2 from the configuration value and assign the result to configuration value A; assign the remainder of configuration value A divided by 3 to configuration variable B. If configuration value B is 1, the target parameter is 0. If configuration value B is 2, the target parameter is 1.

For example, taking Table 4 as an example, when parsing reserved parameters on the second device, for extension type identifier 1, the parameter is initialized to 0, and then a bitwise AND operation is performed between the reserved parameter and 0×01 to get this parameter. For extension type identifier 2, the parameter is initialized to 0, and then a bitwise AND operation is performed between the reserved parameter and 0×02 to get this parameter.

Optionally, after the second device determines the target parameters, it can obtain the data to be decoded from the target encoded data based on the target parameters. For example, if the target parameter for whether the target encoded data can carry second encoded audio data is 1, it indicates that the target encoded data includes second encoded audio data. The second device can obtain the second encoded audio data from the target encoded data and determine it as the data to be decoded. If the target parameter for whether the target encoded data can carry BWE data is 1, it indicates that the target encoded data includes BWE data. The second device can obtain BWE data from the target encoded data and determine it as the data to be decoded.

Optionally, when decoding the data to be decoded, the second device can discard the second encoded audio data and input the first encoded audio data and BWE data to the decoder to obtain the audio frame. For example, when the second device decodes the current audio frame, it does not need the encoded audio data of the Nth previous frame. Therefore, the second device inputs the first encoded audio data of the current audio frame and the BWE data to the decoder, such that the decoder can output the audio frame.

It should be noted that during the decoding process of the second device, although the second device discards the encoded audio data of the Nth previous frame, the encoded audio data of the Nth previous frame is still cached in a buffer pool. If the second device needs the encoded audio data of the Nth previous frame, it can be retrieved from the buffer pool.

An embodiment of this disclosure provides an audio processing method applied to a second device, which receives target encoded data and flag bit data of an audio frame sent from a first device, obtains a configuration value associated with the flag bit data, determines target parameters corresponding to at least one target information associated with the configuration value based on the configuration value, obtains data to be decoded from the target encoded data based on the target parameters, and processes the data to be decoded to obtain the audio frame. In this way, in the scenario of consecutive audio data loss, the second device can restore the lost audio frames based on the first encoded audio data and the second encoded audio data, and improve the clarity of the audio frame based on the BWE data. Since the flag bit data can assist the second device in decoding the target encoded data, the second device can accurately decode the target encoded data, thereby improving the audio quality and enhancing the audio playback effect.

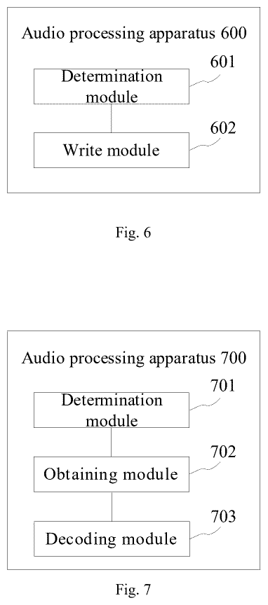

FIG. 6 is a schematic structure diagram of an audio processing apparatus provided by an embodiment of the present disclosure. Referring to FIG. 6, the audio processing apparatus 600 includes: a determination module 601 configured for determining flag bit data based on encoded data information of an audio frame, wherein the encoded data information comprises at least one of configuration information of Multiple Description Coding (MDC), configuration information of in-band Forward Error Correction (FEC) encoding or configuration information of Bandwidth Extension (BWE) data; and a write module 602 configured for writing the flag bit data into a bitstream.

According to one or more embodiments of the present disclosure, the configuration information of MDC comprises information on whether to carry MDC-encoded data, or comprises information on whether to carry the MDC-encoded data and index information of the MDC-encoded data; the configuration information of in-band FEC encoding comprises information on whether to carry in-band FEC-encoded data, or comprises information on whether to carry the in-band FEC-encoded data and offset index information of the in-band FEC-encoded data; and the configuration information of BWE data comprises information on whether to carry the BWE data, or comprises information on whether to carry the BWE data and extension mode information of the BWE data.

According to one or more embodiments of the present disclosure, the determination module 601 is further configured for determining a parameter value for each piece of configuration information in the encoded data information of the audio frame based on the encoded data information of the audio frame; and determining the flag bit data based on a first relationship and the parameter value for the each piece of configuration information, wherein the first relationship comprises a correspondence among target parameter values of the configuration information of MDC, the configuration information of in-band FEC encoding and the configuration information of BWE data, and configuration value(s) of one or more flag bit data.

According to one or more embodiments of the present disclosure, in the first relationship, in response to the target parameter value of whether to carry the MDC-encoded data indicating not carrying the MDC-encoded data, the target parameter value of whether to carry the in-band FEC-encoded data indicates not carrying the in-band FEC-encoded data, the target parameter value of whether to carry the BWE data indicates not carrying the BWE data, and all of target parameter values of index information of the MDC-encoded data, offset index information of the in-band FEC-encoded data, and extension mode information of the BWE data are Null.

According to one or more embodiments of the present disclosure, in the first relationship, in response to the target parameter value of whether to carry the MDC-encoded data indicating carrying the MDC-encoded data, and index information of the MDC-encoded data indicating that the carried MDC-encoded data is encoded data of a first stream, the target parameter value of whether to carry the in-band FEC-encoded data indicates not carrying the in-band FEC-encoded data, the target parameter value of whether to carry the BWE data indicates not carrying the BWE data, and all of target parameter values of index information of the MDC-encoded data, offset index information of the in-band FEC-encoded data, and extension mode information of the BWE data are Null; and in the first relationship, in response to the target parameter value of whether to carry the MDC-encoded data indicating carrying the MDC-encoded data, and the index information of the MDC-encoded data indicating that the carried MDC-encoded data is not encoded data of the first stream, the target parameter value of whether to carry the in-band FEC-encoded data indicates carrying or not carrying the in-band FEC-encoded data, and the target parameter value of whether to carry the BWE data indicates carrying or not carrying the BWE data.

According to one or more embodiments of the present disclosure, the bitstream comprises multiple streams of MDC data, and the determination module 601 is further configured for determining flag bit data corresponding to each of the streams of MDC data based on the encoded data information of the audio frame.

According to one or more embodiments of the present disclosure, the write module 602 is further configured for concatenating the each of the streams of the MDC data with the flag bit data corresponding to the each of the streams of the MDC data; and writing concatenated data into the bitstream.

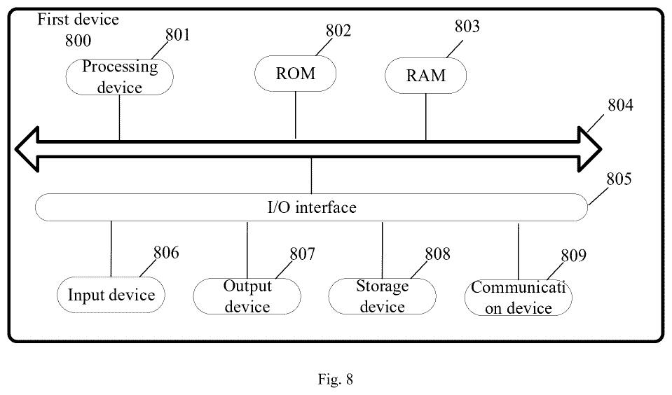

FIG. 7 is a schematic structure diagram of another audio processing apparatus provided by an embodiment of the present disclosure. Referring to FIG. 7, the audio processing apparatus 700 includes: a determination module 701 configured for determining encoded data information based on flag bit data in a bitstream, wherein the encoded data information comprises at least one of configuration information of MDC, configuration information of in-band FEC encoding or configuration information of BWE data; an obtaining module 702 configured for obtaining target encoded data from the bitstream based on the encoded data information; and a decoding module 703 configured for decoding the target encoded data to obtain an audio frame.

According to one or more embodiments of the present disclosure, the obtaining module 702 is further configured for extracting the target encoded data comprising a plurality of parts from the bitstream based on the encoded data information, each of the parts corresponding to an encoding method.

According to one or more embodiments of the present disclosure, the configuration information of MDC comprises information on whether to carry MDC-encoded data, or comprises information on whether to carry the MDC-encoded data and index information of the MDC-encoded data; the configuration information of in-band FEC encoding comprises information on whether to carry in-band FEC-encoded data, or comprises information on whether to carry the in-band FEC-encoded data and offset index information of the in-band FEC-encoded data; and the configuration information of BWE data comprises information on whether to carry the BWE data, or comprises information on whether to carry the BWE data and extension mode information of the BWE data.

According to one or more embodiments of the present disclosure, the determination module 701 is further configured for determining a parameter value for each piece of configuration information in the encoded data information of the audio frame based on the flag bit data; and determining the encoded data information based on a first relationship and the parameter value for the each piece of configuration information, wherein the first relationship comprises a correspondence among the target parameter values of the configuration information of MDC, the configuration information of in-band FEC encoding and the configuration information of BWE data, and configuration value(s) of one or more flag bit data.

An embodiment of the present disclosure further provides an audio processing apparatus comprising a first determination module, a second determination module and a sending module, wherein:
the first determination module is used to determine flag bit data associated with the audio frame, the flag bit data indicating the types of encoded data included in the target encoded data of the audio frame;
the second determination module is used to determine the target encoded data of the audio frame based on the flag bit data, the target encoded data including at least one of first encoded audio data of the audio frame, second encoded audio data of the Nth previous audio frame of the audio frame, or BWE data of the audio frame, the BWE data being associated with the decoding bandwidth of the audio frame, where N is an integer greater than 0; and
the sending module is used to send the target encoded data and the flag bit data to a second device.

According to one or more embodiments of the present disclosure, the second determination module is particularly used to:
obtain a configuration value of the flag bit data;
determine the target encoded data of the audio frame based on the configuration value.

According to one or more embodiments of the present disclosure, the second determination module is particularly used to:
determine, based on the configuration value, target parameters corresponding to at least one target information associated with the configuration value, the target information including at least one of: whether the target encoded data can carry multiple first encoded audio data, a bitstream index of the first encoded audio data, whether the target encoded data can carry second encoded audio data, an offset index of the second encoded audio data, whether the target encoded data can carry BWE data, or the extension mode of the BWE data;
determine the target encoded data of the audio frame based on the target parameters.

According to one or more embodiments of the present disclosure, the second determination module is particularly used to:
obtain a first preset relationship, which includes at least one configuration value and target parameters corresponding to at least one target information associated with the configuration value;
determine the target parameters based on the configuration value and the first preset relationship.

According to one or more embodiments of the present disclosure, the second determination module is particularly used to:
if the target parameter indicates that the target encoded data can carry multiple first encoded audio data, determine that the target encoded data includes the first encoded audio data;
if the target parameter indicates that the target encoded data can carry second encoded audio data, determine that the target encoded data includes the second encoded audio data; and
if the target parameters indicate that the target encoded data can carry the BWE data, determine that the target encoded data includes the BWE data.

According to one or more embodiments of the present disclosure, the types of the encoded data include at least one of: a MDC type, an in-band encoding type, and an extension encoding type;
the audio frame is processed based on an encoding method corresponding to the MDC type to obtain the first encoded audio data;
the audio frame is processed based on an encoding method corresponding to the in-band encoding type to obtain the second encoded audio data; and
the audio frame is processed based on an encoding method corresponding to the extension encoding type to obtain the BWE data.

The audio processing apparatus provided in this embodiment can be used to implement the technical solution of the method embodiment described above. The implementation principle of the apparatus and the technical effect achieved are similar to those of the method embodiment, which will not be repeated here.

An embodiment of the present disclosure further provides an audio processing apparatus, comprising a receiving module used to receive target encoded data of an audio frame and flag bit data sent from a first device, the target encoded data including at least one of first encoded audio data of the audio frame, second encoded audio data of the Nth previous audio frame of the audio frame, and BWE data of the audio frame, the BWE data being associated with the decoding bandwidth of the audio frame, where N is an integer greater than 0;
a decoding module used to decode the target encoded data based on the flag bit data to obtain the audio frame.

According to one or more embodiments of the present disclosure, the decoding module is particularly used to:
obtain a configuration value of the flag bit data; and
obtain the audio frame based on the configuration value.

According to one or more embodiments of the present disclosure, the decoding module is particularly used to:
determine, based on the configuration value, target parameters corresponding to at least one target information associated with the configuration value, the target information including at least one of: whether the target encoded data can carry multiple types of first encoded audio data, an index of the first encoded audio data, whether the target encoded data can carry second encoded audio data, an offset index of the second encoded audio data, whether the target encoded data can carry BWE data, and the extension mode of the BWE data;
extract data to be decoded from the target encoded data based on the target parameters, and process the data to be decoded to obtain the audio frame.

The audio processing apparatus provided in this embodiment can be used to implement the technical solution of the method embodiment described above. The implementation principle of the apparatus and the technical effect achieved are similar to those of the method embodiment, which will not be repeated here.

FIG. 8 is a schematic structure diagram of a first device provided by an embodiment of the present disclosure. Referring now to FIG. 8, a schematic structure diagram of a first device 800 suitable for implementing the embodiments of the present disclosure is shown. The first device 800 may be a terminal device or a server. The terminal device may include, but not limited to, a mobile terminal such as a mobile phone, a notebook computer, a digital broadcast receiver, a PDA (Personal Digital Assistant), a PAD (tablet computer), a PMP (Portable Multimedia Player), an on-board terminal (such as an on-board navigation terminal), and a fixed terminal such as a digital TV, a desktop computer, and the like. The first device shown in FIG. 8 is merely an example and should not impose any limitation on the function and scope of the embodiments of the present disclosure.

As shown in FIG. 8, the first device 800 may include a processing device (e.g., a central processing unit, a graphics processor) 801, which may perform various appropriate actions and processes according to programs stored in Read Only Memory (ROM) 802 or programs loaded from storage device 808 into Random Access Memory (RAM) 803. In RAM 803, various programs and data required for the operation of the first device 800 are also stored. The processing device 801, ROM 802, and RAM 803 are connected to each other through a bus 804. An input/output (I/O) interface 805 is also connected to the bus 804.

Generally, the following devices can be connected to the I/O interface 805: input devices 806 including, for example, a touch screen, a touch pad, a keyboard, a mouse, a camera, a microphone, an accelerometer, a gyroscope, etc; output devices 807 including a liquid crystal display (LCD), a speaker, a vibrator, etc.; a storage device 808 such as a magnetic tape, a hard disk, etc; and a communication device 809. The communication device 809 enables the first device 800 to communicate in a wireless or wired manner with other devices to exchange data. Although FIG. 8 shows the first device 800 with various components, it should be understood that it is not required to implement or have all of these components. Alternatively, more or fewer means can be implemented or provided.

An embodiment of the present disclosure further provides a second device, comprising: a processor and a memory;
wherein the memory is configured to store computer executable instructions;
a processor configured to execute computer executable instructions stored in the memory to cause the processor to implement any of the above embodiments.

An embodiment of the present disclosure further provides a non-transitory computer-readable storage medium having stored thereon computer executable instructions that, when executed by a processor, implement any of the above embodiments.

In particular, according to an embodiment of the present disclosure, the processes described above with reference to the flowchart can be implemented as a computer software program. For example, some embodiments of the present disclosure include a computer program product comprising a computer program carried on a computer-readable medium, the computer program containing program code for performing the method illustrated in the flowcharts. In such an embodiment, the computer program may be downloaded and installed from the network through the communication device 809, or installed from the storage device 808, or from the ROM 802. When the computer program is executed by the processing device 801, the above functions defined in the method of the embodiment of the present disclosure are performed.

It should be noted that the computer readable medium in the present disclosure may be a computer readable signal medium or a computer readable storage medium, or any combination of thereof. The computer readable storage medium can be, for example, but not limited to, an electronic, magnetic, optical, electromagnetic, infrared, or semiconductor system, apparatus, or device, or any combination of the above. More specific examples of the computer readable storage medium may include, but are not limited to: electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing. In the present disclosure, a computer readable storage medium can be any tangible medium that can contain or store a program, which can be used by or in connection with an instruction execution system, apparatus or device. In the present disclosure, a computer readable signal medium may include a data signal that is propagated in the baseband or as part of a carrier, carrying computer readable program code. Such propagated data signals can take a variety of forms including, but not limited to, electromagnetic signals, optical signals, or any suitable combination of the foregoing. The computer readable signal medium can also be any computer readable medium other than a computer readable storage medium, which can transmit, propagate, or transport a program for use by or in connection with the instruction execution system, apparatus, or device. Program code embodied on a computer readable medium can be transmitted by any suitable medium, including but not limited to wire, fiber optic cable, RF (radio frequency), etc., or any suitable combination of the foregoing.

The above computer readable medium may be included in the electronic device described above; or it may exist alone without being assembled into the electronic device.

The aforementioned computer-readable medium carries one or more programs that, when executed by an electronic device, cause the electronic device to perform the methods provided by the above embodiments.

The computer program code for performing the operations of the present disclosure may be written in one or more program design languages or a combination thereof, the program design languages including object-oriented program design languages, such as Java, Smalltalk, C++, etc, as well as conventional procedural program design languages, such as “C” program design language or similar program design language. A program code may be completely or partly executed on a user computer, or executed as an independent software package, partly executed on the user computer and partly executed on a remote computer, or completely executed on a remote computer or server. In the latter circumstance, the remote computer may be connected to the user computer through various kinds of networks, including local area networks (LAN) or wide area networks (WAN), or connected to an external computer (for example, through an Internet connection provided by an Internet service provider).

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. It should also be noted that, in some alternative implementations, the functions noted in the block may occur out of the order noted in the drawings. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units involved in the embodiments described in the present disclosure can be implemented in software or hardware. Wherein, the name of a unit does not constitute a limitation of the unit itself under certain circumstances, for example, a first acquisition unit may also be described as “a unit that obtains at least two Internet Protocol addresses”.

The functions described above may be performed at least in part by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD), etc.

In the context of the present disclosure, a machine-readable medium may be a tangible medium, which may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of thereof. More specific examples of the machine-readable storage medium may include electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing.

It should be noted that the modifications of “a” and “a plurality of” mentioned in the present disclosure are illustrative and not restrictive, and those skilled in the art should understand that unless clearly indicated in the context, they should be understood as “one or more”.

The names of messages or information exchanged between multiple devices in the embodiments of the present disclosure are only used for illustrative purposes, and are not used to limit the scope of these messages or information.

It can be understood that before using the technical solutions disclosed in the embodiments of this disclosure, users should be appropriately informed about the type of personal information involved, the scope of use and application scenarios of the personal information, etc. in accordance with relevant laws and regulations, and authorization should be obtained from the users.

For example, in response to receiving a user's active request, a prompt message is sent to the user to clearly inform the user that the requested operation requires the collection and use of the user's personal information. Thus, the user can independently choose whether to provide personal information to software or hardware, such as the electronic device, application, server, or storage media, that performs the operation of the disclosed technical solution based on the prompted information.

As an optional but not limited implementation method, in response to receiving an active user request, a prompt message may be sent to the user via a pop-up window in which a text prompt message may be presented. In addition, the pop-up window may also include a selection control for the user to choose whether to “agree” or “disagree” to provide personal information to the electronic device.

It can be understood that the above notification and user authorization process is only illustrative and does not constitute a limitation on the implementation method of this disclosure. Other methods that comply with relevant laws and regulations may also be applied to the implementation method of this disclosure.

It can be understood that the data involved in this technical solution (including but not limited to the data itself, the acquisition or use of data) should comply with the requirements of applicable laws, regulations and relevant rules. The data may include information, parameters, messages, etc., such as traffic steering indication information.

The above description is only preferred embodiments of the present disclosure and an explanation of the applied technical principles. Those skilled in the art should understand that the scope of disclosure involved in this disclosure is not limited to the technical solutions formed by the specific combination of the above technical features, and should also cover other technical solutions formed by any combination of the above technical features or their equivalent features without departing from the disclosed concept, for example, technical solutions formed by replacing the above features with technical features having similar functions to (but not limited to) those disclosed in the present disclosure.

In addition, although the operations are depicted in a specific order, this should not be understood as requiring these operations to be performed in the specific order shown or performed in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments can also be implemented in combination in a single embodiment. Conversely, various features described in the context of a single embodiment can also be implemented in multiple embodiments individually or in any suitable subcombination.

Although the subject matter has been described in language specific to structural features and/or logical actions of the method, it should be understood that the subject matter defined in the appended claims is not necessarily limited to the specific features or actions described above. On the contrary, the specific features and actions described above are merely exemplary forms of implementing the claims.

What is claimed is:

1. An audio processing method, comprising:
determining flag bit data based on encoded data information of an audio frame, wherein the encoded data information comprises at least one of configuration information of Multiple Description Coding (MDC), configuration information of in-band Forward Error Correction (FEC) encoding or configuration information of Bandwidth Extension (BWE) data; and
writing the flag bit data into a bitstream.

2. The audio processing method according to claim 1, wherein:
the configuration information of MDC comprises information on whether to carry MDC-encoded data, or comprises information on whether to carry the MDC-encoded data and index information of the MDC-encoded data;
the configuration information of in-band FEC encoding comprises information on whether to carry in-band FEC-encoded data, or comprises information on whether to carry the in-band FEC-encoded data and offset index information of the in-band FEC-encoded data; and
the configuration information of BWE data comprises information on whether to carry the BWE data, or comprises information on whether to carry the BWE data and extension mode information of the BWE data.

3. The audio processing method according to claim 1 wherein the determining the flag bit data based on the encoded data information of the audio frame comprises:
determining a parameter value for each piece of configuration information in the encoded data information of the audio frame based on the encoded data information of the audio frame; and
determining the flag bit data based on a first relationship and the parameter value for the each piece of configuration information, wherein the first relationship comprises a correspondence among target parameter values of the configuration information of MDC, the configuration information of in-band FEC encoding and the configuration information of BWE data, and configuration value(s) of one or more flag bit data.

4. The audio processing method according to claim 3, wherein in the first relationship, in response to the target parameter value of whether to carry the MDC-encoded data indicating not carrying the MDC-encoded data, the target parameter value of whether to carry the in-band FEC-encoded data indicates not carrying the in-band FEC-encoded data, the target parameter value of whether to carry the BWE data indicates not carrying the BWE data, and all of target parameter values of index information of the MDC-encoded data, offset index information of the in-band FEC-encoded data, and extension mode information of the BWE data are Null.

5. The audio processing method according to claim 3, wherein:
in the first relationship, in response to the target parameter value of whether to carry the MDC-encoded data indicating carrying the MDC-encoded data, and index information of the MDC-encoded data indicating that the carried MDC-encoded data is encoded data of a first stream, the target parameter value of whether to carry the in-band FEC-encoded data indicates not carrying the in-band FEC-encoded data, the target parameter value of whether to carry the BWE data indicates not carrying the BWE data, and all of target parameter values of index information of the MDC-encoded data, offset index information of the in-band FEC-encoded data, and extension mode information of the BWE data are Null; and
in the first relationship, in response to the target parameter value of whether to carry the MDC-encoded data indicating carrying the MDC-encoded data, and the index information of the MDC-encoded data indicating that the carried MDC-encoded data is not encoded data of the first stream, the target parameter value of whether to carry the in-band FEC-encoded data indicates carrying or not carrying the in-band FEC-encoded data, and the target parameter value of whether to carry the BWE data indicates carrying or not carrying the BWE data.

6. The audio processing method according to claim 1, wherein the bitstream comprises multiple streams of MDC data, and the determining the flag bit data based on the encoded data information of the audio frame comprises:
determining flag bit data corresponding to each of the streams of MDC data based on the encoded data information of the audio frame.

7. The audio processing method according to claim 6, wherein the writing the flag bit data into the bitstream comprises:
concatenating the each of the streams of the MDC data with the flag bit data corresponding to the each of the streams of the MDC data; and
writing concatenated data into the bitstream.

8. An audio processing method, comprising:
determining encoded data information based on flag bit data in a bitstream, wherein the encoded data information comprises at least one of configuration information of MDC, configuration information of in-band FEC encoding or configuration information of BWE data;
obtaining target encoded data from the bitstream based on the encoded data information; and
decoding the target encoded data to obtain an audio frame.

9. The audio processing method according to claim 8, wherein the obtaining the target encoded data from the bitstream based on the encoded data information comprises:
extracting the target encoded data comprising a plurality of parts from the bitstream based on the encoded data information, each of the parts corresponding to an encoding method.

10. The audio processing method according to claim 8, wherein:
the configuration information of MDC comprises information on whether to carry MDC-encoded data, or comprises information on whether to carry the MDC-encoded data and index information of the MDC-encoded data;
the configuration information of in-band FEC encoding comprises information on whether to carry in-band FEC-encoded data, or comprises information on whether to carry the in-band FEC-encoded data and offset index information of the in-band FEC-encoded data; and
the configuration information of BWE data comprises information on whether to carry the BWE data, or comprises information on whether to carry the BWE data and extension mode information of the BWE data.

11. The audio processing method according to claim 9, wherein the determining the encoded data information based on the flag bit data in the bitstream comprises:
determining a parameter value for each piece of configuration information in the encoded data information of the audio frame based on the flag bit data; and
determining the encoded data information based on a first relationship and the parameter value for the each piece of configuration information, wherein the first relationship comprises a correspondence among the target parameter values of the configuration information of MDC, the configuration information of in-band FEC encoding and the configuration information of BWE data, and configuration value(s) of one or more flag bit data.

12. An electronic device, comprising:
a memory;
a processor configured to execute computer executable instructions stored in the memory to cause the processor to preform an audio processing method comprising:
determining flag bit data based on encoded data information of an audio frame, wherein the encoded data information comprises at least one of configuration information of Multiple Description Coding (MDC), configuration information of in-band Forward Error Correction (FEC) encoding or configuration information of Bandwidth Extension (BWE) data; and
writing the flag bit data into a bitstream.

13. The electronic device according to claim 12, wherein:
the configuration information of MDC comprises information on whether to carry MDC-encoded data, or comprises information on whether to carry the MDC-encoded data and index information of the MDC-encoded data;
the configuration information of in-band FEC encoding comprises information on whether to carry in-band FEC-encoded data, or comprises information on whether to carry the in-band FEC-encoded data and offset index information of the in-band FEC-encoded data; and
the configuration information of BWE data comprises information on whether to carry the BWE data, or comprises information on whether to carry the BWE data and extension mode information of the BWE data.

14. The electronic device according to claim 12, wherein the determining the flag bit data based on the encoded data information of the audio frame comprises:
determining a parameter value for each piece of configuration information in the encoded data information of the audio frame based on the encoded data information of the audio frame; and
determining the flag bit data based on a first relationship and the parameter value for the each piece of configuration information, wherein the first relationship comprises a correspondence among target parameter values of the configuration information of MDC, the configuration information of in-band FEC encoding and the configuration information of BWE data, and configuration value(s) of one or more flag bit data.

15. The electronic device according to claim 14, wherein in the first relationship, in response to the target parameter value of whether to carry the MDC-encoded data indicating not carrying the MDC-encoded data, the target parameter value of whether to carry the in-band FEC-encoded data indicates not carrying the in-band FEC-encoded data, the target parameter value of whether to carry the BWE data indicates not carrying the BWE data, and all of target parameter values of index information of the MDC-encoded data, offset index information of the in-band FEC-encoded data, and extension mode information of the BWE data are Null.

16. The electronic device according to claim 14, wherein:
in the first relationship, in response to the target parameter value of whether to carry the MDC-encoded data indicating carrying the MDC-encoded data, and index information of the MDC-encoded data indicating that the carried MDC-encoded data is encoded data of a first stream, the target parameter value of whether to carry the in-band FEC-encoded data indicates not carrying the in-band FEC-encoded data, the target parameter value of whether to carry the BWE data indicates not carrying the BWE data, and all of target parameter values of index information of the MDC-encoded data, offset index information of the in-band FEC-encoded data, and extension mode information of the BWE data are Null; and
in the first relationship, in response to the target parameter value of whether to carry the MDC-encoded data indicating carrying the MDC-encoded data, and the index information of the MDC-encoded data indicating that the carried MDC-encoded data is not encoded data of the first stream, the target parameter value of whether to carry the in-band FEC-encoded data indicates carrying or not carrying the in-band FEC-encoded data, and the target parameter value of whether to carry the BWE data indicates carrying or not carrying the BWE data.

17. The electronic device according to claim 12, wherein the bitstream comprises multiple streams of MDC data, and the determining the flag bit data based on the encoded data information of the audio frame comprises:
determining flag bit data corresponding to each of the streams of MDC data based on the encoded data information of the audio frame.

18. An electronic device, comprising:
a memory;
a processor configured to execute computer executable instructions stored in the memory to cause the processor to preform the audio processing method according to claim 8.

19. A non-transitory computer-readable storage medium stored thereon computer executable instructions that, when executed by a processor, implement the audio processing method according to claim 1.

20. A non-transitory computer-readable storage medium stored thereon computer executable instructions that, when executed by a processor, implement the audio processing method according to claim 8.
